(19) United States
(12) Patent Application Publication
(10) Pub. No.: US 2016/0117075 A1
(43) Pub. Date: Apr. 28, 2016

(54) ADVANCED TOUCH USER INTERFACE

(71) Applicant: ROVIO ENTERTAINMENT LTD, Espoo (FI)

(72) Inventor: Stanislav STANKOVIC, Tampere (FI)

(73) Assignee: ROVIO ENTERTAINMENT LTD., Espoo (FI)

(21) Appl. No.: 14/891,376

(22) PCT Filed: May 7, 2014
(86) PCT No.: PCT/FI2014/050336

§ 371 Date: Nov. 16, 2015

(30) Foreign Application Priority Data
May 14, 2013 (FI) 20135508

(51) Int. Cl. G06F 3/0488; G06F 3/041

(52) U.S. Cl. CPC G06F 3/0488; G06F 3/0412; G06F 3/0414

(57) ABSTRACT

The present invention is based on a touch based control of a user terminal. The touch based control may comprise a touch screen, a touch pad or other touch user interface enabling “multitouch”, where a touch sensing surface is able to recognize presence of two or more touch points. Two detected touch points on the sensing surface define end points of a line segment. Length of the line segment is determined providing basis for a first control signal and angle of the line segment compared to a reference line is determined providing basis for a second control signal. These control signals are used to control a moving object in a virtual space.

### FIELD OF THE INVENTION

The present invention relates to usability and more specifically to a method, a device and a computer program product with an enhancement to touch user interface controlled applications, as defined in the preambles of the independent claims.

### BACKGROUND OF THE INVENTION

Conventionally user interface control methods have been implemented with a keyboard, a mouse, a gaming controller and such. Lately, touch based user interface such as touch screens and touch pads have become very popular in mobile phones, tablet computers, gaming devices, laptops and such. Many devices can be used for gaming or other uses, where a moving object is being controlled in a virtual space. In addition to the listed conventional controls methods some devices comprise sensors that sense tilting of the screen. This tilting is translated to control commands that change direction of motion of a display object in the virtual application space accordingly. The problem of these solutions is that the user's focus to the screen and events in it are easily compromised, when the display screen is constantly moved.

In another conventional solution, the display is made to comprise separate control regions in which the user may move fingers to input control commands. Such input regions, however, limit the use of the display, and force the user to hold the device rigidly in a specific manner throughout the use of the application. In addition the separate control regions on a touch base user interface limit the freedom of an application designer when designing a layout of an application.

Nowadays quite popular solution for handling objects like images is using two fingers for zooming in and out. An application publication WO2011003171 in area of graphical design discloses a method for manipulating a graphic widget by tracking the x-y-positions of two touch points associated with the graphic widget. In the some examples the widget is rotated in the x-y-plane in accordance with changes in the angle of a line that passes between the positions of the two touch points, and the z-position of the widget is modified in accordance with changes in the distance between the x-y-positions of the touch point. These control schemes are, however, not applicable for motion-based applications. It is easy to understand that there is practically no use e.g. for a game where a display object would only move when the user moves fingers on the touch screen. In motion-based applications, the display object is expected to progress in the virtual space independently according to a predefined motion scheme. The basic requirement for motion-based application is that the user can monitor independent progress of the object, and every now and then adjust the progress according to his or her will.

In motion-based applications, the display object is expected to progress in the virtual space independently according to a predefined motion scheme. The basic requirement for motion-based application is that the user can monitor independent progress of the object, and every now and then adjust the progress according to his or her will.

### BRIEF DESCRIPTION OF THE INVENTION

The object of the present invention is to enhance user experience of applications running on a user terminal. The objects of the present invention are achieved with a method, a system and a computer program product according to the characterizing portions of the independent claims.

The preferred embodiments of the invention are disclosed in the dependent claims.

The present invention is based on a touch based control of a user terminal. The touch based control may comprise a touch screen, a touch pad or other touch user interface enabling “multitouch”, where a touch sensing surface is able to recognize presence of two or more touch points. Two detected touch points on the sensing surface define end points of a line segment. Length of the line segment is determined providing basis for a first control signal and angle of the line segment compared to a reference line is determined providing basis for a second control signal. These control signals are used to control a moving object in a virtual space.

The present invention has the advantage that the user is able to hold and control the user device in ergonomic way touching the touch surface on most suitable areas. Furthermore, especially when using a touch screen the user is able to decide where to lay fingers for controlling and which parts to remain visible. Furthermore an application designer has more freedom to design layout for the application when control areas do not need to be fixed.

### BRIEF DESCRIPTION OF THE FIGURES

In the following the invention will be described in greater detail, in connection with preferred embodiments, with reference to the attached drawings, in which

FIG. 1 illustrates an exemplary user terminal as a block diagram;

FIG. 2 illustrates a simplified touch screen;

FIG. 3 illustrates a method implemented in a user terminal;

FIG. 4 further illustrates a method in a user terminal;

FIG. 5 shows a flow chart illustrating a method implemented in the user terminal;

FIG. 6 illustrates an example of an embodiment in the user terminal.

### DETAILED DESCRIPTION OF SOME EMBODIMENTS

The following embodiments are exemplary. Although the specification may refer to “an”, “one”, or “some” embodiment(s), this does not necessarily mean that each such reference is to the same embodiment(s), or that the feature only applies to a single embodiment. Single features of different embodiments may be combined to provide further embodiments.

In the following, features of the invention will be described with a simple example of a system architecture in which various embodiments of the invention may be implemented. Only elements relevant for illustrating the embodiments are described in detail. Various implementations of the information system comprise elements that are generally known to a person skilled in the art and may not be specifically described herein.

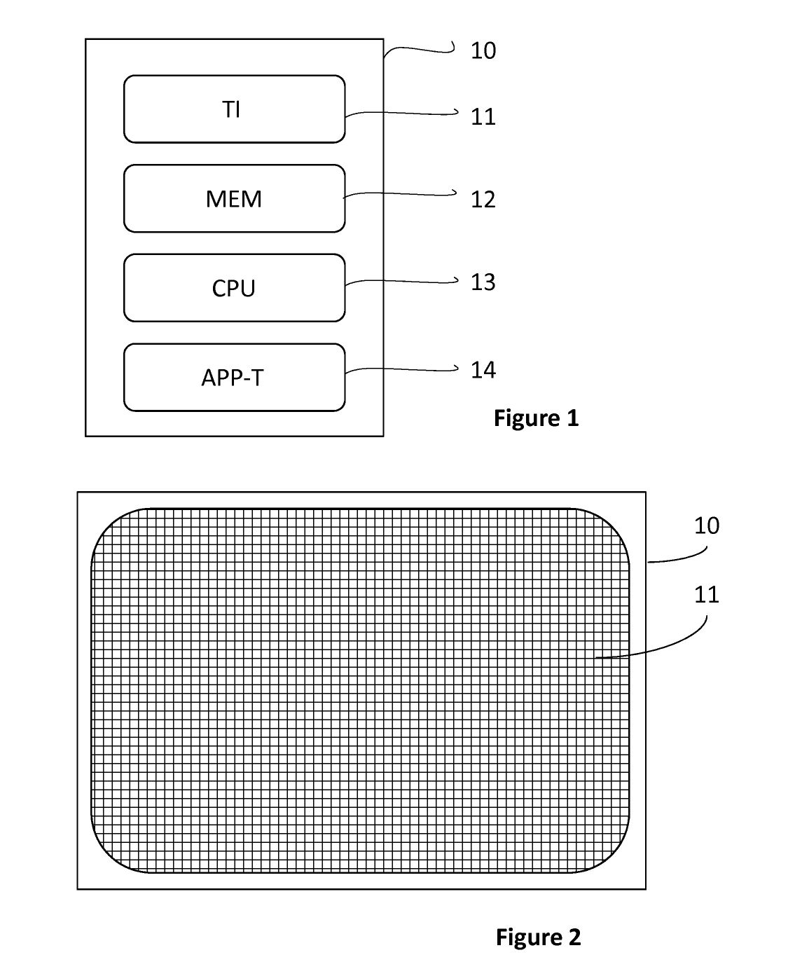

FIG. 1 illustrates an exemplary user terminal 10 as a block diagram depicting some of the relevant components. The user terminal 10 may be for example a laptop, desktop computer, graphics tablet, cellular phone, multimedia system of a vehicle, an arcade gaming device, an electronic noticeboard, or any other device with a touch sensitive surface for inputting information. In addition to the depicted components the user terminal 10 may also comprise many components typical for mobile phones, tablet computers, gaming devices etc.

The user terminal 10 comprises a processor unit (CPU) 13 for performing systematic execution of operations upon data. The processor unit 13 is an element that essentially comprises one or more arithmetic logic units, a number of special registers and control circuits. Memory unit (MEM) 12 provides a data medium where computer-readable data or programs, or user data can be stored. The memory unit is connected to the processor unit 13. The memory unit 12 may comprise volatile or non-volatile memory, for example EEPROM, ROM, PROM, RAM, DRAM, SRAM, firmware, programmable logic, etc.

The device also comprises a touch interface unit (TI) 11 for inputting data to the internal processes of the device and at least one output unit for outputting data from the internal processes of the device. In addition to the touch interface unit 11 the device may comprise other user interface units, such as with a keypad, a microphone, and equals for inputting user data and a screen, a loudspeaker, and equals for outputting user data. The interface units of the device may also comprise a network interface unit that provides means for network connectivity.

The processor unit 13, the memory unit 12, and the touch interface unit 11 are electrically interconnected to provide means for systematic execution of operations on received and/or stored data according to predefined, essentially programmed processes of the device. These operations comprise the means, functions and procedures described herein for the user terminal.

In general, various embodiments of the device may be implemented in hardware or special purpose circuits, software, logic or any combination thereof. Some aspects may be implemented in hardware, while some other aspects may be implemented in firmware or software, which may be executed by a controller, microprocessor or other computing apparatus. Software routines, which are also called as program products, are articles of manufacture and can be stored in any device-readable data storage medium and they include program instructions to perform particular tasks.

While various aspects of the invention have illustrated and described as block diagrams, message flow diagrams, flow charts and logic flow diagrams, or using some other pictorial representation, it is well understood that the illustrated units, blocks, device, system elements, procedures and methods may be implemented in, for example, hardware, software, firmware, special purpose circuits or logic, a computing device or some combination thereof.

The terminal application 14 is an autonomously processed user controllable application that is, or may be stored in a memory of a user terminal and provides instructions that, when executed by a processor unit of the user terminal perform the functions described herein. The expression autonomously processed means that after the application has been installed to the user terminal, the application may be executed locally in the user terminal without having to request information from an external application server or without having to submit information to one. Such exchange of information with the application server may be possible but the content of the exchanged information does not control progress of events in the application and therefore exchange of information with the external server is not mandatory for execution of the application. The expression user-controlled means that the user terminal 10 in which the application is executed comprises a user interface and the user may control execution of the application by means of the user interface. The user may thus initiate and terminate running of the application, provide commands that control the order of instructions being processed in the user terminal.

FIG. 2 depicts the user terminal 10 with the touch interface unit 11. The touch interface unit 11 may be an electronic visual display that the user can control through multi-touch gestures by touching the screen with one or more fingers. Some touchscreens can also detect objects such as a stylus or ordinary or specially coated gloves. The user can use the touchscreen to react to what is displayed and to control how it is displayed.

The touch interface unit 11 may also be a touchpad (trackpad), which is a pointing device featuring a touch sensitive surface for translating motion and position of a user's fingers to a relative position on screen. Touchpads are a common feature of laptop computers, and are also used as a substitute for a mouse where desk space is scarce. Separate wired/wireless touchpads are also available as detached accessories. The touch interface unit may also be implemented on surface of the user terminal 10—for example on front or back cover of the terminal.

Underlying technology of the touch interface unit 11 may be for example based on resistive, capacitive, surface acoustic wave, infrared, optical imaging, dispersive signal technology, acoustic pulse recognition etc. Term “touch” means in addition to physical touching of a surface also other means of detecting a control gesture. Some technologies are able to detect a finger or any pointing device near a surface and in embodiments utilizing optical imaging there might be only a virtual surface if any.

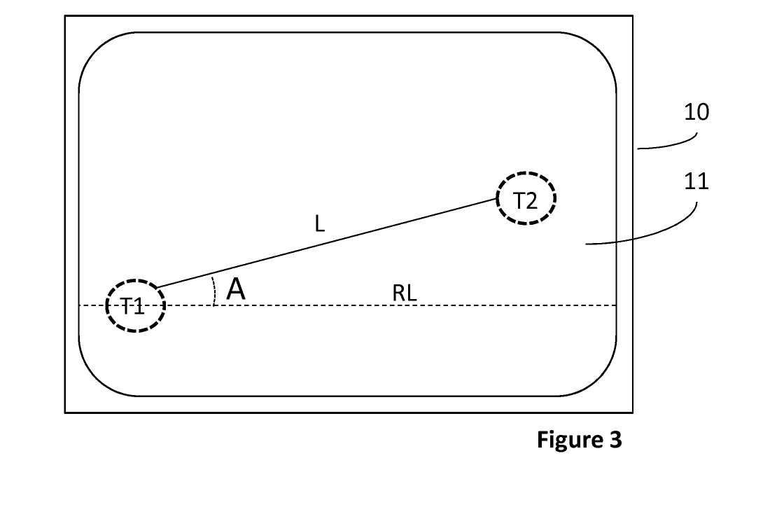

FIG. 3 shows an example of the current invention embodied on the user terminal 10 having the touch interface unit 11. Touch point T1 indicates first location of contact on the touch interface unit 11 and T2 indicates a second location on contact on the touch interface unit 11. The touch points T1, T2 may be touched in any order or essentially at the same time. In some embodiments there may also be more than two touch points. Touch points T1 and T2 define end points for a line segment L. Distance between the touch points T1 and T2 defines length of the line segment L (T1, T2).

FIG. 3 also shows a reference line RL. The reference line RL is used to define angle A for the line segment L. In FIG. 3 the reference line L is depicted as a horizontal line in relation to the user terminal 10. It is clear to a man skilled in the art that the reference line can also be defined as a vertical or in any angle in relation to the user terminal 10. The reference line RL may also be defined by an edge of the touch interface unit 11. An application designer may define the reference line RL freely and it may dynamically change according to the current situation of the terminal application APP-T.

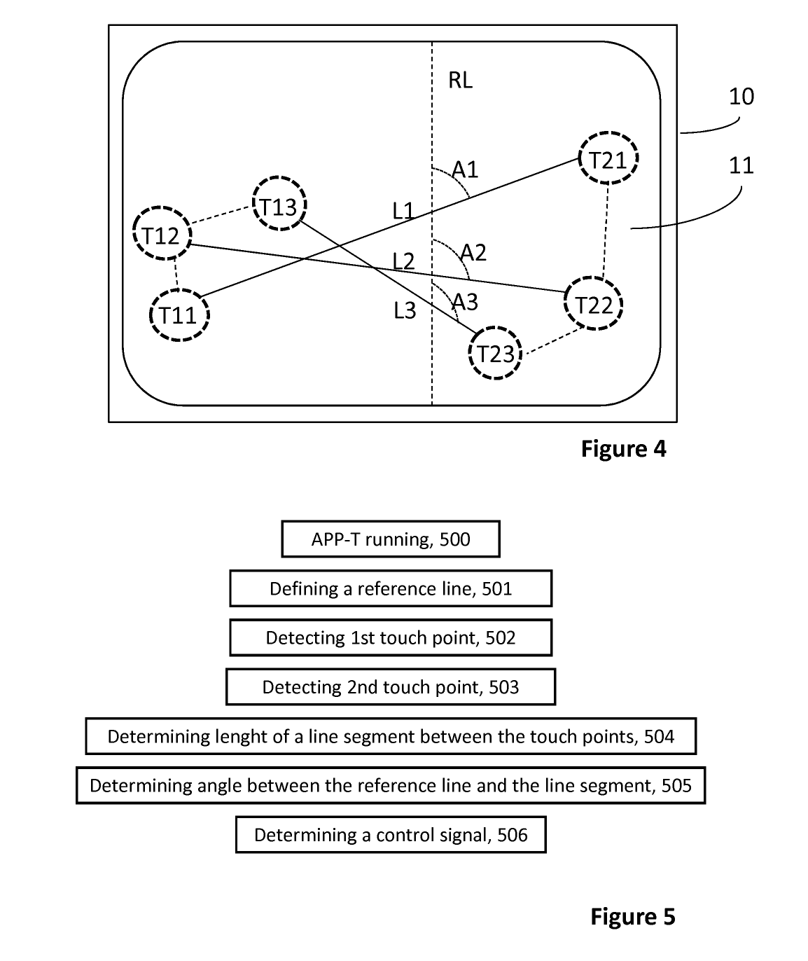

FIG. 4 further depicts an example of the current invention embodied of the user terminal 10 having the touch interface unit 11. Three different control situations are shown but there could be an undefined number of control situations between the shown situations. In picture 4 the reference line RL is defined as vertical in relation to the user terminal 11. The three situations shown:
Touch points T11 and T21 define segment line L1 and angle A1
Touch points T12 and T22 define segment line L2 and angle A2
Touch points T13 and T23 define segment line L3 and angle A3
Touch points T1x and T2x define segment line Lx and angle Ax (not shown)

Dotted lines between the touch points T11, T12, and T13 as well as the touch points T21, T22, and T23 illustrate a track of contacts on the touch interface unit 11. As discussed above all these dotted lines may consist of undefined number of touch points. Also for simplicity the dotted lines are shown as straight lines but they could be of any shape or curvature. Furthermore in some situations the any of the touch points may remain unchanged for any given period.

For any control situation line segment Lx and angle Ax can be defined with touch points T1x and T2x.

Distance between touch points T1x and T2x is determined by APP-T 14 resulting a value for a first variable Var1 representing length of line segment Lx.

Angle Ax between the segment line Lx and the reference line RL is determined by APP-T 14 resulting a value for a second variable Var2 representing angle between the reference line RL and the line segment Lx.

| 1st | 2nd | | | | |
|---|---|---|---|---|---|
| touch | touch | | | Var1 | Var2 |
| point | point | Length | Angle | value | value |
| T11 | T21 | L1 | A1 | V11 | V21 |
| T12 | T22 | L2 | A2 | V12 | V22 |
| T13 | T23 | L3 | A3 | V13 | V23 |
| T14 | T24 | L4 | A4 | V14 | V24 |
| T15 | T25 | L5 | A5 | V15 | V25 |
| . . . | . . . | . . . | . . . | . . . | . . . |
| T1x | T2x | Lx | Ax | V1x | V2x |

In FIG. 5 a simplified flow chart depicts one embodiment of the invented method.

Terminal application APP-T is running 500 on the user terminal 10. A reference line RL is defined 501. At the touch interface unit 11 first touch point is detected 502 and a second touch point is detected 503. Based on the two touch points a line segment and its length is determined 504. Using the reference line RL and the line segment angle between those is determined 505. Using the length and angle information a control signal is determined 506.

It is clear to a man skilled in the art that the invented method can be implemented as part of an operating system of a user terminal or as part of an application or as a separate application. Order of the steps is not confined as shown in FIG. 5. For example defining a reference line, 501 could be after step 502 or 503 or 504.

According to an embodiment current invention enables control of a display object in a virtual space where, in the absence of control input, the display object moves with a predefined motion scheme. Predefined motion scheme may be a physical modeling of a space with surfaces and forces (air-resistance, friction, gravity . . . ) affecting the moving object and also physical characteristics of the moving object (size, weight, performance . . . ). Furthermore the predefined motion scheme may include more advanced variables like force per unit mass—G-force. When a control signal is detected it affects the movement of the moving object in the virtual space together with the motion scheme. The motion scheme may be one or more processes running on the APP-T 14.

In the invention, two control input points are detected and a line segment between them determined. Changing the angle A of the line segment L and a reference line RL creates an incremental change to variable Var1 or Var2. Further, a change of length of the detected line segment L creates an incremental change to variable Var1 or Var2. Variables Var1 and Var2 can be interpreted to represent any controls signal of the moving object in virtual space. Non exhaustive list of control signals: direction of movement, curvature of movement, rotation, yaw, pitch roll, speed, acceleration, deceleration, rise, descent. The direction of movement may mean changing a course of movement directly from one place to another. It may also mean changing a course of movement along a curvature.

According to another embodiment of the invention changing the angle A between the line segment L and reference line RL creates an incremental change in direction of the moving object in virtual space.

According to another embodiment of the invention changing the angle A between the line segment L and the reference line RL essentially in a way that the segment line is turned clockwise creates an incremental change in direction of the moving object in virtual space to right.

According to another embodiment of the invention changing the angle A between the line segment L and the reference line RL essentially in a way that the segment line is turned counterclockwise creates an incremental change in direction of the moving object in virtual space to left.

According to another embodiment of the invention the angle A between the line segment L and the reference line RL essentially in a way that the segment line is turned counterclockwise creates an incremental change in direction of the moving object in virtual space to left.

According to another embodiment of the invention keeping the angle A between the line segment L and the reference line RL non-changed retains current direction of the movement of the moving object in virtual space to left.

According to another embodiment of the invention changing the length of the line segment L creates an incremental change in speed of the moving object in virtual space.

According to another embodiment of the invention changing the length of the line segment L to shorter creates an incremental change in speed of the moving object in virtual space by decreasing the speed.

According to another embodiment of the invention changing the length of the line segment L to shorter creates an incremental change in speed of the moving object in virtual space by increasing the speed.

According to another embodiment of the invention keeping the length of the line segment L non-changed retains the latest speed of the movement of the moving object in virtual space to left.

According to another embodiment of the invention detecting the length of the line segment L being zero (or within set threshold) stops the movement.

According to another embodiment of the invention in the absence of control input, the moving object moves with a predefined direction and speed scheme.

Term “virtual space” refers to a landscape, environment or other scene designed to be viewed on a user terminal display. The virtual space may be built to resemble a real world space or it can be a product of imagination or any combination of those. As an example the virtual space can be a highly detailed representation of a real world city or a race track. On the other hand the virtual space can be an imaginary space in outer space or a village in an imaginary land. In practice the virtual space can represent, anything limited only by imagination. In a virtual space the user appear to be inside the scene. More or less the user feels being in a different place being able to interact with the space—compared to a static representation or a movie. The user is able to turn, go up and down. The virtual space may be implemented in the terminal application 14.

Term “moving object” refers to a display item moving in the virtual space. The moving object may be in any form or shape resembling a real world object or it can be a product on imagination or any combination of those. As an example the moving object can be a highly detailed representation of a real world racing car, aircraft, motorbike etc. or a person. On the other hand the moving object can be an imaginary spacecraft or an imaginary animal. In practice the moving object can represent anything, limited only by imagination. The moving object can be controlled in the virtual space by the user. The moving object can be moved to different directions using different velocities and means for moving. The moving object may be implemented in the terminal application 14.

The invented procedure allows a user to intuitively control a moving object in virtual space using a touch interface. Touch resolutions of the modern touch interface technologies enable very smooth control giving a very accurate control. Being able to control a moving object in a virtual space where the movement is defined by a set of rules and the movement can be continuous gives the user a realistic experience. Being able to set fingers anywhere on the touch interface it is very ergonomic and pleasant for the user to use the device.

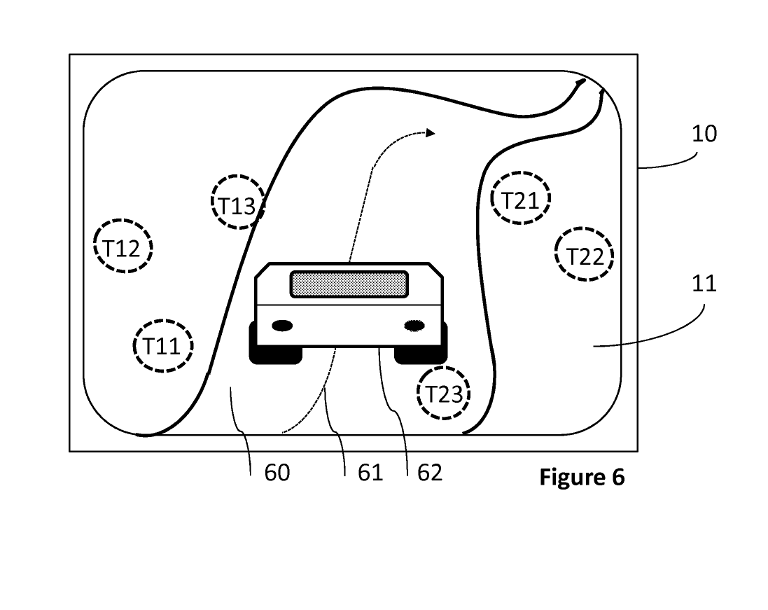

As an example, let us consider that the application is a racing game. The game is running on a user terminal 10 equipped with a touch interface unit 11. Game application is running on the user terminal 10. FIG. 6 depicts a situation from the racing game. Virtual space in the example is an imaginary racing track 60 with many turns and hills going in an imaginary scenery.

The moving object in this example is a racing car 62 depicted from rear. In the depicted situation the racing car has just passed a turn to left and is on a straight closing to a turn to right. The dotted line represents a driving line of the racing car 62 as it is moving as a user is controlling. Touch points T11&T12, T12&T22 and T13&T23 represent three control situations through the depicted part of the racing track 60.

Looking at FIG. 4 a reference line L is defined and for each on the three situations (and undefined number of other situations not shown) the length of the segment line L and angle A between the reference line RL and the segment line L are defined and values for variables Var1 and Var2 are determined. Reference line RL, line segments L1, L2, L3 and angles A1, A2, A3 are not shown in FIG. 6 for simplicity.

Going back to racing situation of FIG. 6 the racing car has just passed a turn to left. Touch points T11 and T22 define a line segment L tilted to the left (counter clockwise) defining the angle A causing the racing car to turn left along the racing track 60 at speed defined by the distance between the touch points—the length of the line segment L.

After the turn comes a straight and touch points T12 and T22 define a line segment L—essentially horizontal—causing the racing car 62 to travel straight along the racing track 60 at speed defined by the distance between the touch points—the length of the line segment L. The length of the line segment L is now longer causing the racing car 62 to travel faster.

Next along the racing track 60 comes a turn to right. Touch points T13 and T23 define a line segment L tilted to the right (clockwise) defining the angle A causing the racing car to turn right along the racing track 60 at speed defined by the distance between the touch points—the length of the line segment L. The length of the line segment L is now shorter causing the racing car 62 to travel slower.

The angle A in this example emulates turning steering wheel and eventually front wheels of the racing car 62. The more the line segment L is tilted the more the front wheel are turned causing the car to turn.

The length of the line segment L in this example emulates position of accelerator (gas pedal) of the racing car 62. The longer the line segment L is the faster the racing car 62 goes. Certain threshold for shortness of the length of the line segment L can be defined to emulate using brakes of the racing car 62.

Additional control means can be added to the game—for example tapping with either of the thumbs or a finger could emulate for example gear change.

If the user decides to remove the thumbs from the touch interface unit 10—no control signal—the racing car 62 is configured to act like a real car when a driver removes hands from steering wheel and feet from pedals: steering centers and the car slowly stops.

The example depicted in FIG. 6 enables the user to imaging using a virtual steering wheel on the touch interface unit 11. Using for example two thumbs the user is able to turn the virtual steering wheel and by adjusting the diameter of the virtual steering wheel to adjust the speed of the racing car 62. There are no predefined control areas and therefore the user is able to lay the thumbs on which ever location that feels the best. The game designer is able to design the scenery more freely when separate areas for control do not need to be defined.

It is apparent to a person skilled in the art that as technology advances, the basic idea of the invention can be implemented in various ways. The invention and its embodiments are therefore not restricted to the above examples, but they may vary within the scope of the claims.

1. A method, comprising:
running an application in an apparatus for controlling a moving object in a virtual space, wherein the moving object moves according to a motion scheme;
defining a reference line;
detecting a first touch point on a touch interface unit;
detecting a second touch point on the touch interface unit;
determining a length of a line segment defined by the first and the second touch point;
determining an angle between the line segment defined by the first and the second touch point and the reference line;
determining at least one control signal from the length of the line segment and the angle between the line segment and the reference line; and
controlling the moving object in the virtual space according to the motion scheme and the at least one control signal.

2. A method according to claim 1 further comprising, detecting the first and the second touch point, at least partly, simultaneously.

3. A method according to claim 1 further comprising defining, the reference line using an edge of the touch interface unit.

4. A method according to claim 1 further comprising, using the determined angle to control a direction of movement of the moving object.

5. A method according to claim 1 further comprising, using the determined length to control a speed of movement of the moving object.

6. A method according to claim 1 further comprising, detecting the line segment tilting right or left, and defining one of the at least one control signal for the moving object accordingly to cause the moving object to turn towards left or right.

7. A method according to claim 1 further comprising, detecting that the length is below a threshold length; and causing movement of the moving object to stop.

8. A method according to claim 1, wherein the motion scheme includes parameters emulating physical characteristics of the moving object.

9. An apparatus comprising means for implementing a method according to claim 1.

10. An apparatus according to claim 9, wherein the apparatus is a mobile device.

11. A computer program product embodied on a non-transitory computer-readable medium, readable by a computer and encoding instructions for executing a method according to claim 1.

12. An apparatus comprising at least one processors, at least one memory containing computer program code, wherein the at least one processors and the at least one memory are configured to cause the apparatus at least to:
run an application that controls a moving object in a virtual space and wherein the moving object moves according to a motion scheme;
define a reference line;
detect a first touch point on a touch interface unit that is connected to the apparatus;
detect a second touch point on the touch interface unit;
determine a length of a line segment defined by the first and the second touch point;
determine an angle between the line segment defined by the first and the second touch point and the reference line;
determine at least one control signal from the length of the line segment and the angle between the line segment and the reference line; and
control the moving object in the virtual space according to the motion scheme and the at least one control signal.

13. An apparatus according to claim 12, wherein the first and the second touch point are detected, at least partly, simultaneously.

14. An apparatus according to claim 12, wherein the reference line is defined using an edge of the touch interface unit.

15. An apparatus according to claim 12, wherein the determined angle is used to control a direction of movement of the moving object.

16. An apparatus according to claim 12, wherein the determined length is used to control a speed of movement of the moving object.

17. An apparatus according to claim 12, wherein the at least one processor and the at least one memory are further configured to cause the apparatus to:
detect the line segment tilting right or left, and
define one of the at least one control signals for the moving object such that it causes the moving object to turn towards left or right according to the detected tilting.

18. An apparatus according to claim 12, wherein detecting that the length is below a threshold length causes the movement of the moving object to stop.

19. An apparatus according to claim 12, wherein the motion scheme includes parameters emulating physical characteristics of the moving object.

20. A non-transitory computer readable medium having stored a set of computer readable instructions which, when executed by at least one processors, cause the apparatus to at least:
run an application that controls a moving object in a virtual space and wherein the moving object moves according to a motion scheme;
define a reference line;
detect a first touch point on a touch interface unit that is connected to the apparatus;
detect a second touch point on the touch interface unit;
determine a length of a line segment defined by the first and the second touch point;
determine an angle between the line segment defined by the first and the second touch point and the reference line;
determine at least one control signal from the length of the line segment and the angle between the line segment and the reference line; and
control the moving object in the virtual space according to the motion scheme and the at least one control signal.
